(19) United States
(12) Patent Application Publication
(10) Pub. No.: US 2012/0326966 A1
(43) Pub. Date: Dec. 27, 2012

(54) GESTURE-CONTROLLED TECHNIQUE TO EXPAND INTERACTION RADIUS IN COMPUTER VISION APPLICATIONS

(75) Inventor: Peter Hans RAUBER, San Diego, CA (US)

(73) Assignee: QUALCOMM Incorporated, San Diego, CA (US)

(21) Appl. No.: 13/457,840

(22) Filed: Apr. 27, 2012

Related U.S. Application Data
(60) Provisional application No. 61/499,645, filed on Jun. 21, 2011.

(51) Int. Cl. G06F 3/01

(52) U.S. Cl. 345/156

(57) ABSTRACT

The invention describes a method and apparatus to expand a radius of the interaction in computer vision applications with the real world within the field of view of a display unit of a device. The radius of interaction is expanded using a gesture in front of an input sensory unit, such as a camera that signals the device to allow a user the capability of extending and interacting further into the real and augmented world with finer granularity. In one embodiment, the device electronically detects the gesture generated by the user's extremity as obtained by the camera coupled to the device. In response to detecting the gesture, the device changes the shape of a visual cue on the display unit coupled to the device, and updates the visual cue displayed on the display unit.

### CROSS-REFERENCES TO RELATED APPLICATIONS

This application claims priority to U.S. Provisional Application No. 61/499,645 entitled “Gesture-Controlled Technique to Expand Interaction Radius in Computer Vision Applications,” filed Jun. 21, 2011, and is hereby incorporated by reference.

### BACKGROUND

Computer vision allows a device to perceive the environment in the device's vicinity. Computer vision enables applications in augmented reality by allowing the display device augment the reality of a user's surroundings. Modern day hand-held devices like tablets, smart phones, video game consoles, personal digital assistants, point-and-shoot camera and mobile devices may enable a few forms of computer vision by having a camera capture the sensory input. In these hand-held devices, the useful area of interaction for the user with the device is limited by the length of the user's arm. This geometrical limitation of interaction of the user with the real world consequentially limits the ability of the user's interaction with objects in the real and augmented world facilitated by the hand-held device. Therefore, the user is limited to the interaction on the hand-held device's screen or to a small area limited by the length of the user's arm.

The spatial restriction of the interaction between the user and the device is exasperated in augmented reality where the hand-held device needs to be positioned within the user's field of view with one hand. The other unoccupied hand can be used to interact with the device or with the real world. The geometric limitation on the space for the user to interact with is limited to an arm's length of the user holding the hand-held device and the maximum distance between the user and the hand-held device for the user to comfortably view the display unit.

Another problem presented with the hand-held device is the limitation on the granularity of control achieved by using a finger to interact with the touch screens on a device. Furthermore, with the advances in technology, the screen resolution is rapidly increasing allowing the device to display more and more information. The increase in screen resolution is leading to the diminishing ability of the users to accurately interact with the device at finer granularities. To help alleviate the problem, some device manufacturers provide wands that allow for finer granularity of control for the users. However, the carrying, safeguarding and retrieving of yet another article to operate the hand-held device has presented a significant bar in the market acceptance of these wands.

### SUMMARY

Techniques are provided to expand the radius of the activity with the real world within the field of view of the camera using a gesture in front of the camera to allow the user the capability of extending and interacting further into the real and augmented world with finer granularity.

For example, the expansion of the radius of the activity of the real world is triggered by a hand or finger gesture performed in the field of view of the camera. This gesture is recognized and results in a visual extension of the hand or finger far into the field of view presented by the display unit of the device. The extended extremity can then be used to interact with more distant objects in the real and augmented world.

An example of a method to enhance computer vision applications involving a user's at least one pre-defined gesture may include electronically detecting at least one pre-defined gesture generated by a user's extremity as obtained by a camera coupled to a device; in response to detecting the at least one pre-defined gesture, changing a shape of a visual cue on a display unit coupled to the device; and updating the visual cue displayed on the display unit in response to detecting a movement of the user's extremity. The device may be one of a hand-held device, video game console, tablet, smart phone, point-and-shoot camera, personal digital assistant and mobile device. In one aspect, the visual cue comprises a representation of the user's extremity and changing the shape of the visual cue includes extending the visual cue on the display unit further into a field of view presented by the display unit. In another aspect, changing the shape of the visual cue comprises narrowing a tip of the representation of the user's extremity presented by the display unit.

In one example setting, the device detects the pre-defined gesture generated by a user's extremity in a field of view of the rear-facing camera. In another example setting, the device detects the pre-defined gesture generated by a user's extremity in a field of view of the front-facing camera.

In some implementations, the at least one pre-defined gesture comprises a first gesture and a second gesture, wherein upon detecting the first gesture the device activates a mode that allows changing the shape of the visual cue and upon detecting the second gesture the device changes the shape of the visual cue displayed on the display unit. In one embodiment, the visual cue may comprise a representation of an extension of the user's extremity displayed on the display unit coupled to the device. In another embodiment, the visual cue may comprise a virtual object selected by the at least one pre-defined gesture and displayed on the display unit coupled to the device. Extending the visual cue on the display unit may comprise tracking of the movement and a direction of the movement of the user's extremity, and extending of the visual cue on the display unit in the direction of the movement of the user's extremity, wherein extending of the visual cue represented on the display unit of the device in a particular direction is directly proportional to the movement of the user's extremity in that direction.

An example device implementing the system may include a processor; an input sensory unit coupled to the processor; a display unit coupled to the processor; and a non-transitory computer readable storage medium coupled to the processor, wherein the non-transitory computer readable storage medium may comprise code executable by the processor for implementing a method comprising electronically detecting at least one pre-defined gesture generated by a user's extremity as obtained by a camera coupled to a device; in response to detecting the at least one pre-defined gesture, changing a shape of a visual cue on a display unit coupled to the device; and updating the visual cue displayed on the display unit in response to detecting a movement of the user's extremity.

The device may be one of a hand-held device, video game console, tablet, smart phone, point-and-shoot camera, personal digital assistant and mobile device. In one aspect, the visual cue comprises a representation of the user's extremity and changing the shape of the visual cue includes extending the visual cue on the display unit further into a field of view presented by the display unit. In another aspect, changing the shape of the visual cue comprises narrowing a tip of the representation of the user's extremity presented by the display unit.

In one example setting, the device detects the pre-defined gesture generated by a user's extremity in a field of view of the rear-facing camera. In another example setting, the device detects the pre-defined gesture generated by a user's extremity in a field of view of the front-facing camera. In some implementations, the at least one pre-defined gesture comprises a first gesture and a second gesture, wherein upon detecting the first gesture the device activates a mode that allows changing the shape of the visual cue and upon detecting the second gesture the device changes the shape of the visual cue displayed on the display unit.

Implementations of such a device may include one or more of the following features. In one embodiment, the visual cue may comprise a representation of an extension of the user's extremity displayed on the display unit coupled to the device. In another embodiment, the visual cue may comprise a virtual object selected by the at least one pre-defined gesture and displayed on the display unit coupled to the device. Extending the visual cue on the display unit may comprise tracking of the movement and a direction of the movement of the user's extremity, and extending of the visual cue on the display unit in the direction of the movement of the user's extremity, wherein extending of the visual cue represented on the display unit of the device in a particular direction is directly proportional to the movement of the user's extremity in that direction.

An example non-transitory computer readable storage medium coupled to a processor, wherein the non-transitory computer readable storage medium comprises a computer program executable by the processor for implementing a method comprising electronically detecting at least one pre-defined gesture generated by a user's extremity as obtained by a camera coupled to a device; in response to detecting the at least one pre-defined gesture, changing a shape of a visual cue on a display unit coupled to the device; and updating the visual cue displayed on the display unit in response to detecting a movement of the user's extremity.

The device may be one of a hand-held device, video game console, tablet, smart phone, point-and-shoot camera, personal digital assistant and mobile device. In one aspect, the visual cue comprises a representation of the user's extremity and changing the shape of the visual cue includes extending the visual cue on the display unit further into a field of view presented by the display unit. In another aspect, changing the shape of the visual cue comprises narrowing a tip of the representation of the user's extremity presented by the display unit.

In one example setting, the device detects the pre-defined gesture generated by a user's extremity in a field of view of the rear-facing camera. In another example setting, the device detects the pre-defined gesture generated by a user's extremity in a field of view of the front-facing camera. In some implementations, the at least one pre-defined gesture comprises a first gesture and a second gesture, wherein upon detecting the first gesture the device activates a mode that allows changing the shape of the visual cue and upon detecting the second gesture the device changes the shape of the visual cue displayed on the display unit.

Implementations of such a non-trasitory computer readable storage product may include one or more of the following features. In one embodiment, the visual cue may comprise a representation of an extension of the user's extremity displayed on the display unit coupled to the device. In another embodiment, the visual cue may comprise a virtual object selected by the at least one pre-defined gesture and displayed on the display unit coupled to the device. Extending the visual cue on the display unit may comprise tracking of the movement and a direction of the movement of the user's extremity, and extending of the visual cue on the display unit in the direction of the movement of the user's extremity, wherein extending of the visual cue represented on the display unit of the device in a particular direction is directly proportional to the movement of the user's extremity in that direction.

An example apparatus performing a method to enhance computer vision applications, the method comprising a means for electronically detecting at least one pre-defined gesture generated by a user's extremity as obtained by a camera coupled to a device; in response to detecting the at least one pre-defined gesture, a means for changing a shape of a visual cue on a display unit coupled to the device; and a means for updating the visual cue displayed on the display unit in response to detecting a movement of the user's extremity.

The device may be one of a hand-held device, video game console, tablet, smart phone, point-and-shoot camera, personal digital assistant and mobile device. In one aspect, the visual cue comprises a means for representing a user's extremity and a means for changing the shape of the visual cue includes a means for extending the visual cue on the display unit further into a field of view presented by the display unit. In another aspect, changing the shape of the visual cue comprises a means for narrowing a tip of the representation of the user's extremity presented by the display unit.

In one example setting, the device detects the pre-defined gesture generated by a user's extremity in a field of view of the rear-facing camera. In another example setting, the device detects the pre-defined gesture generated by a user's extremity in a field of view of the front-facing camera. In some implementations, the at least one pre-defined gesture comprises a first gesture and a second gesture, wherein upon detecting the first gesture the device has a means for activating a mode that allows a means for changing the shape of the visual cue and upon detecting the second gesture the device changes the shape of the visual cue displayed on the display unit.

An exemplary setting for the apparatus in the system for performing the method may include one or more of the following. In one embodiment, the visual cue may comprise a means for representing an extension of the user's extremity displayed on the display unit coupled to the device. In another embodiment, the visual cue may comprise a virtual object selected by the at least one pre-defined gesture and displayed on the display unit coupled to the device. Extending the visual cue on the display unit may comprise a means for tracking of the movement and a direction of the movement of the user's extremity, and extending of the visual cue on the display unit in the direction of the movement of the user's extremity, wherein extending of the visual cue represented on the display unit of the device in a particular direction is directly proportional to the movement of the user's extremity in that direction.

The foregoing has outlined rather broadly the features and technical advantages of examples according to disclosure in order that the detailed description that follows can be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

### BRIEF DESCRIPTION OF THE DRAWINGS

The following description is provided with reference to the drawings, where like reference numerals are used to refer to like elements throughout. While various details of one or more techniques are described herein, other techniques are also possible. In some instances, well-known structures and devices are shown in block diagram form in order to facilitate describing various techniques.

A further understanding of the nature and advantages of examples provided by the disclosure can be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 illustrates an exemplary user configuration setting for using an embodiment of invention on a hand-held device.

FIG. 2 illustrates another exemplary user configuration setting for using an embodiment of invention on a hand-held device.

FIG. 3 illustrates yet another exemplary user configuration setting for using an embodiment of invention on a hand-held device.

FIG. 4 illustrates an example of a pre-defined gesture used by the user for practicing embodiments of the invention.

FIG. 5 is a simplified flow diagram, illustrating a method 500 for expanding the interaction radius with a hand-held device in a computer vision application.

FIG. 6 is another simplified flow diagram, illustrating a method 600 for expanding the interaction radius with a hand-held device in a computer vision application.

FIG. 7 is another simplified flow diagram, illustrating a method 700 for expanding the interaction radius with a hand-held device in a computer vision application.

FIG. 8 is yet another simplified flow diagram, illustrating a method 800 for expanding the interaction radius with a hand-held device in a computer vision application.

FIG. 9 illustrates an exemplary computer system incorporating parts of the device employed in practicing embodiments of the invention.

### DETAILED DESCRIPTION

Embodiments of the invention include techniques for expanding the radius of interaction with the real world within the field of view of a camera using a pre-defined gesture. The pre-defined gesture by the user in front of the camera coupled to a device allows the user to extend the user's reach into the real and augmented world with finer granularity.

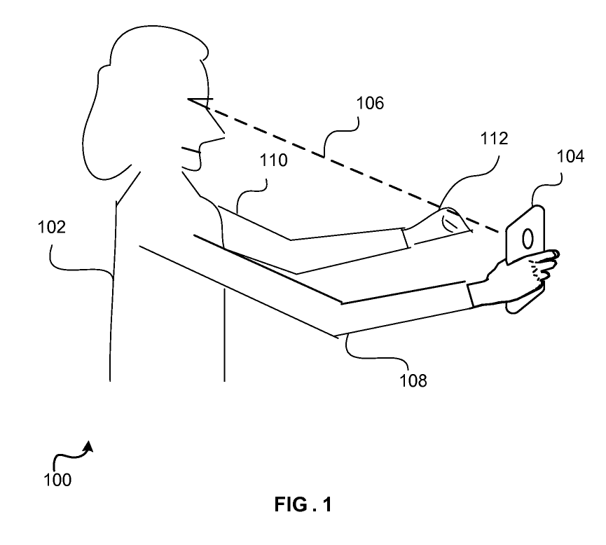

Referring to the example of FIG. 1, the user 102 interacts with a hand-held device 104 by holding the hand-held device in one hand and interacting with the hand-held device with the unoccupied hand. The maximum radius of the user's 102 interaction with the hand-held device 104 is determined by how far out the user can stretch their arm 108 holding the hand-held device 104. The maximum radius of the user's interaction with the hand-held device 104 is also restricted by the distance that the user 102 can push out the hand-held device without significantly compromising the user's ability to see the display unit of the hand-held device 104. A hand-held device 104 may be any computing device with an input sensory unit such as a camera and a display unit coupled to the computing device. Examples of hand-held devices include but are not limited to video game consoles, tablets, smart phones, personal digital assistants, point-and-shoot cameras and mobile devices. In one embodiment, the hand-held device may have a front-facing camera and a rear-facing camera. In some implementations, the front-facing camera and the display unit are placed on the same side of the hand-held device, so that the front facing camera is facing the user when the user is interacting with the display unit of the hand-held device. The rear-facing camera, in many instances, may be located on the opposite side of the hand-held device. While in use, the rear-facing camera coupled to the hand-held device may be facing in a direction away from the user. In the above described configuration setting, the user 102 has one arm 110 and one hand 112 unoccupied and free to interact in the field of view of the hand-held device 104. The field of view of the hand-held device is the extent of the observable real world that is sensed at any given moment at the input sensory unit. In this configuration, the useful area of interaction for the user 102 with the hand-held device 104 is limited to the area between the hand-held device 104 and the user 102. In some embodiments, where the display unit is also a touch-screen, the user can interact with the device through the touch screen display unit. The spatial limitation with respect to the space the user 102 can interact with in the real world consequentially limits the ability of the user to interact with object in the real and augmented world facilitated by the hand-held device. Therefore, the user 102 is limited to the interaction on the device's screen or to a small area between the user 102 and the hand-held device 104.

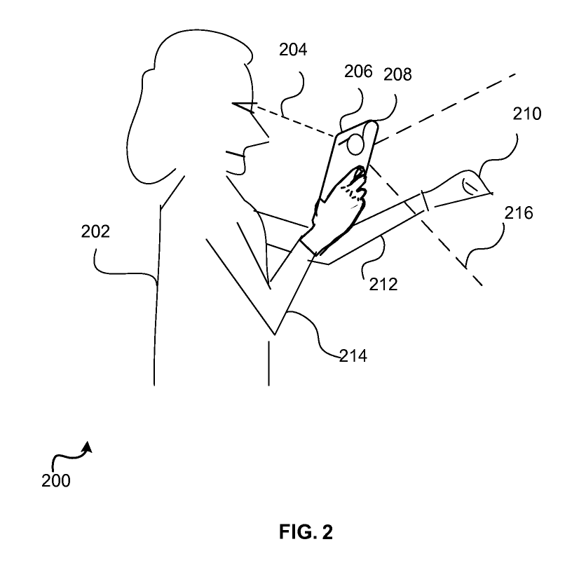

Embodiments of the invention allow the user to overcome the spatial limitation described while referring to the example of FIG. 1 by increasing the radius of interaction with the hand-held device 104 and consequently the radius of interaction with the real and augmented world. Referring to the example of FIG. 2, in one embodiment, the user 202 is looking directly 204 at the display unit of the hand-held device 206. The hand-held device 206 has an input sensory unit 208. In one embodiment, the input sensory unit is a rear-facing camera on the side of the hand-held device facing away from the user. The field of view 216 of the camera extends away from the user, towards the real world. The user's free arm 212 and free hand 210 can interact with the real and augmented world in the field of view 216 of the camera. The configuration described in FIG. 2 allows the user to increase the radius of interaction beyond the camera. Also, the user 202 can hold the hand-held device 206 much closer so that the user has good visibility of the details displayed on the display unit of the hand-held device 206 while interacting within the field of view of the camera.

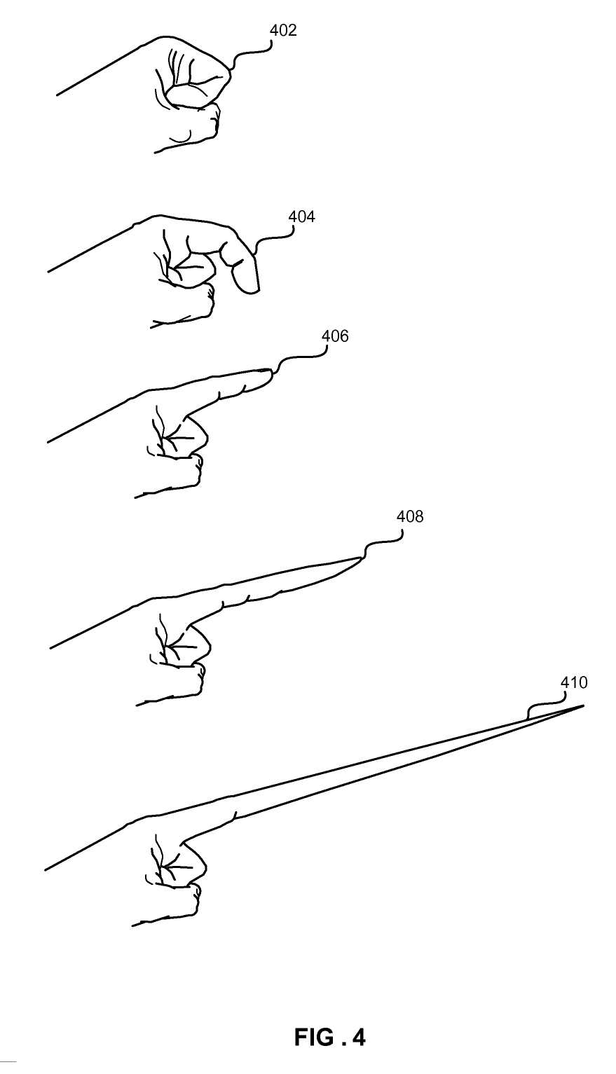

In one embodiment of the invention, the hand-held device detects a pre-defined gesture by the user using his/her extremity in the field of view 216 of the rear-facing camera to further expand the radius of the interaction with the hand-held device 206. The gesture can be the unfurling of a finger (as shown in FIG. 4) or any other distinct signature that the hand-held device 206 can detect as a hint that the user 202 may want to expand the depth and radius of interaction in the augmented world. In some embodiments, the hand-held device activates a mode upon detection of the pre-defined gesture that allows the user to practice embodiments of the invention. The hand-held device 206 may be pre-programmed to recognize pre-defined gestures. In another embodiment, the hand-held device 206 can learn new gestures or update the definition of known gestures. Additionally, the hand-held device may facilitate a training mode that allows the hand-held device 206 to learn new gestures taught by the user.

Upon detection of a pre-defined gesture, the hand-held device 206 may enter a mode that allows the extension of the visual cue into the real and augmented world as presented on the display unit. The hand-held device 206 accomplishes the extension of radius of interaction by allowing the extension of a visual cue further into the field of view 216 presented by the display unit. In some embodiments, the visual cue may be a human extremity. Examples of human extremities may include a finger, a hand, an arm or a leg. The visual cue may be extended in the field of view presented by the display unit by the hand-held device 206 by changing the shape of the visual cue. For example, if the visual cue is a finger, the finger may be further elongated as presented to the user on the display unit. In another implementation, the finger may be narrowed and sharpened to create the visual effect of elongating the finger. In yet another embodiment, the finger may be presented by the display unit as both elongated and narrowed. The field of view displayed on the display unit may also be adjusted by zooming the image in and out to further increase the reach of the visual cue.

The hand held device 206 allows the extended user extremity to interact with and manipulate more distinct objects in the real and augmented world with a much longer reach and with a much finer granularity. For example, embodiments of the invention may be used to precisely manipulate a small cube that is 2 meters away in the augmented reality. The speed and direction of a particular movement can be used to determine how far the human extremity extends into the real or augmented world. In another example, the device may allow the user to select text on a far away bulletin board for translation by the hand-held device 206 in a foreign country. Embodiments of the invention embedded in the hand-held device may allow the user to reach out to the bulletin board using the visual cue and select the foreign language text for translation. The types of interaction of the extended human extremity with the object may include but is not limited to pointing, shifting, turning, pushing, grasping, rotating, and clamping objects in the real and augmented world.

The visual cue from the extended user extremity also replaces the need of a wand for interacting with hand-held devices. The wand allows the user to interact with objects displayed on the display unit of a touch screen at a finer granularity. However, the user needs to carry the wand and retrieve it each and every time the user wants to interact with the hand-held device using the wand. Also, the granularity of the wand is not adjustable. The visual cue generated from the extended user extremity also provides the benefits of finer granularity attributed to a wand. Narrowing and sharpening of the user's extremity as displayed on the display unit of the hand-held device 206 allows the user to select or manipulate objects at a much finer granularity. The use of the visual cue displayed on the display unit of the hand-held device 206 also allows the user to select and manipulate objects in a traditional display of elements by the display unit. For instance, the visual cue may allow the user to work with applications that need finer granularity of control and are feature rich like Photoshop® or simply select a person from a picture from out of a crowd. Similarly, in an augmented reality setting the instant access to a visual cue with fine granularity would allow the user to select a person with much greater ease from a crowd that is in the field of view of the camera and displayed on the display unit of the hand-held device 206.

Referring back to the example of FIG. 1, the hand-held device may also perform embodiments of the invention that are described while referring to FIG. 2. In FIG. 1, the area of interaction with the hand-held device 104 is primarily limited to the space between the user 102 and the hand-held device 104. With a hand-held device that has a front-facing camera facing the user 102, the user 102 can use his/her hand or finger to interact with the hand-held device. A pre-defined gesture by the user 102 may hint the camera to display a visual cue on the display unit. The visual cue may be a representation of the finger or hand of the user. As the user 102 moves his/her finger forward, the representation of the finger may narrow and sharpen allowing finer granularity interaction with the device. If the hand-held device 104 has cameras on both the sides of the device, the user can also interact with objects in augmented reality in the FIG. 1 configuration. In one implementation, a representation of the finger or the hand detected by the camera on the side facing the user 102 is superimposed on the display unit displaying the field of view visible to the camera on the side facing away from the user.

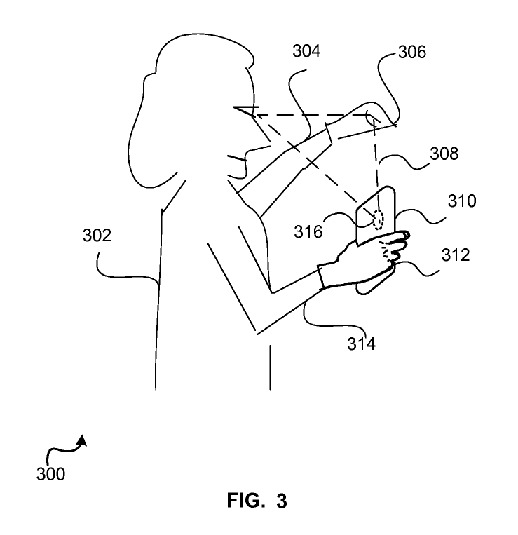

Referring to FIG. 3, as another example configuration setting for practicing an embodiment of the invention, the user 302 can stretch out their left arm 304 in front of their body or towards the left of their body as long as the left hand 306 is within the field of view of the input sensory unit 316 for the hand-held device 310. The user 302 holds the hand-held device 310 in their right hand 312. The device has an input sensory unit 316 that is a front-facing camera that is on the side facing towards the user. The user's hand, the user's eyes and the device may form a triangle 308 allowing the user added flexibility in interacting with the device. This configuration is similar to the configuration discussed for FIG. 1. However, this configuration allows for a greater radius of interaction for the user 302 with the hand-held device 310. Embodiments of the invention can be practiced by the hand-held device 310 as discussed for FIG. 1 and FIG. 2 above.

FIG. 4 illustrates an example gesture by the user detected by the hand-held device to operate an embodiment of the invention. The hand-held device may detect the unfurling of a finger as a hint to extend the reach of the finger into the field of view presented by the display unit. In this embodiment, the user starts the interaction with the augmented world with a clinched hand (block 402). The device is either pre-programmed or trained to detect the unfurling of the finger as a valid interaction with the augmented world. As the hand-held device detects the user unfurling the finger (blocks 404-406) the hand-held device enters a mode that allows the extension of the radius of interaction of the user into the real or augmented world. As user moves the finger at a pre-determined speed (velocity) or faster, the hand-held device detects the interaction with the augmented world and may begin the extension of the finger (block 408) into the field of view displayed by the display unit and perceived by the user. As the user's hand continues to move in the direction the user is pointing towards, the hand-held device displays the finger becoming longer and more pointed (block 410). The hand-held device may also extend the finger in response to acceleration of the finger (change of speed in a particular direction). As the hand-held device detects that the finger is becoming longer and more pointed, the hand-held device allows the user to extend the finger's reach further into the real and augmented reality and exert finer grain manipulation in the real and augmented world. Similarly, the detection of the retraction of the finger by the hand-held device shortens and broadens the tip of the finger all the way back to the original size of the hand and the finger on the display unit.

In another embodiment, the hand-held device recognizes a gesture by the user that allows the user to activate a virtual object. The selection of the virtual object may also depend on the application running at the time the gesture is recognized by the hand-held device. For instance, the hand-held device may select a golf club when the application running in the foreground on the hand-held device is a golf gaming application. Similarly, if the application running in the foreground is a photo editing tool the virtual object selected could be a paint brush or a pencil instead. Examples of a virtual object could be a virtual wand, virtual golf club or a virtual hand. The virtual objects available for selection may also be displayed as a bar menu on the display unit. In one implementation, repetitive or distinct gestures could select different virtual objects from the bar menu. Similarly, as described above, the speed and direction of the movement of the user with their extremity while the virtual object is active may cause the virtual object to extend or retract into the real or augmented world proportionally.

Detection of different gestures by the hand-held device may activate different extension modes and virtual objects simultaneously. For instance, a device may activate an extension mode triggered by the user that allows the user to extend the reach of their arm by the movement of the arm followed by the reach of their finger by unfurling the finger.

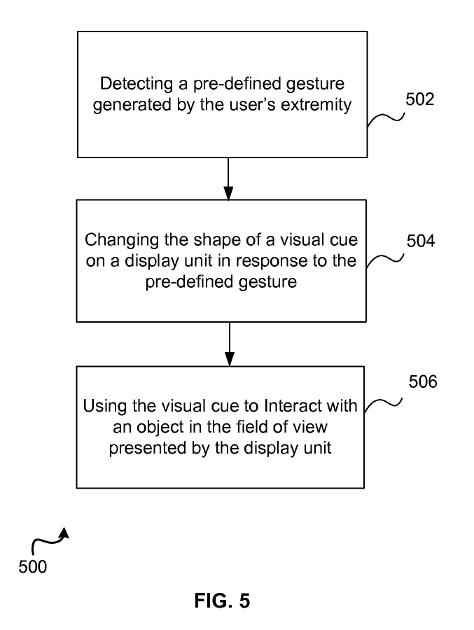

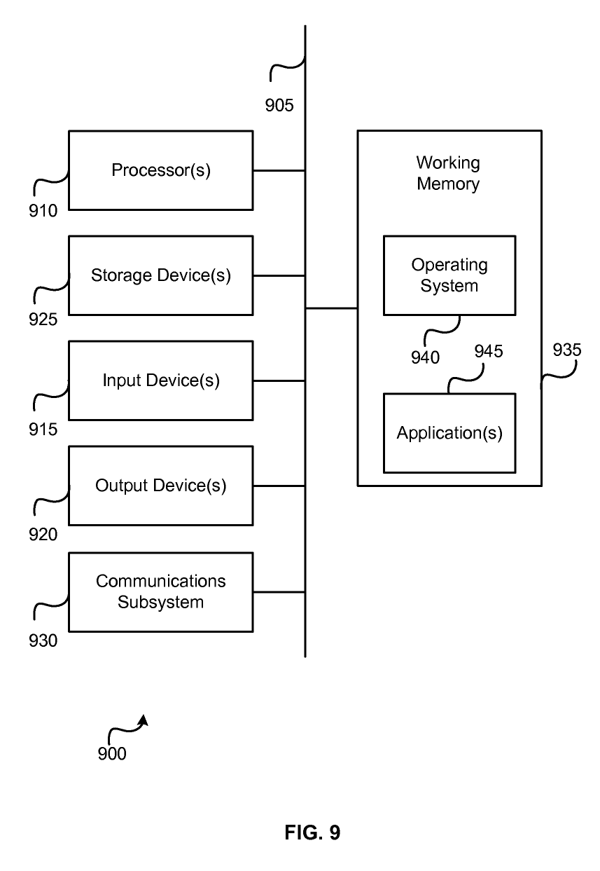

FIG. 5 is a simplified flow diagram, illustrating a method 500 for expanding the interaction radius in a computer vision application. The method 500 is performed by processing logic that comprises hardware (circuitry, dedicated logic, etc.), software (such as is run on a general purpose computing system or a dedicated machine), firmware (embedded software), or any combination thereof. In one embodiment, the method 500 is performed by device 900 of FIG. 9. The method 500 may be performed in the configuration settings described in FIG. 1, FIG. 2 and FIG. 3.

Referring to the example flow from FIG. 5, at block 502, the user generates a pre-defined gesture in the field of view of the input sensory device of the hand-held device. The pre-defined gesture is electronically detected by the input sensory unit of the device. In one embodiment, the input sensory unit is a camera. The hand-held device may have a front-facing camera and/or a rear-facing camera. In some implementations, the front-facing camera and the display unit are placed on the same side of the hand-held device, so that the front facing camera is facing the user when the user is interacting with the display unit of the hand-held device. The rear-facing camera, in many instances, may be located on the opposite side of the hand-held device. While in use, the rear-facing camera coupled to the device may be facing in a direction away from the user. In response to the pre-defined gesture, at block 504, the shape of a visual cue may be changed in the field of view presented by the display unit of the hand-held device to the user. At block 506, the hand-held device uses the extended visual cue to interact with an object in the field of view presented by the display unit.

At block 504, the change in the shape of the visual cue allows the user to bridge the gap between the real world and the augmented world. The size and characteristics of the user's arm, hand and fingers are not suitable for interacting with objects in the augmented world. The hand-held device by changing the shape of the extremity or any other visual cue allows the user to manipulate the objects displayed on the display unit of the hand-held device. In some embodiments, the field of view displayed by the display unit may also be altered by the hand-held device to give the perception of the change in the shape of the visual cue. In an example setting, the display unit of the hand-held device may display a room with a door. Using current technologies, emulating turning of the door knob by the user with the same precision in movement as the user would use in the real world is difficult. Even if prior-art hand-held device can capture the detail in the movement by the user, prior-art hand-held devices are incapable of projecting the detail of the door and the user's interaction with the door to the user in a meaningful way for the user to manipulate the door knob with precision. The embodiments of the present invention performed by the hand-held device may change the shape of the visual cue, for instance, by drastically shrinking the size of the arm and the hand (that is present in the field of view of the camera) that may allow the user to interact with the door knob with precision.

It should be appreciated that the specific steps illustrated in FIG. 5 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 500.

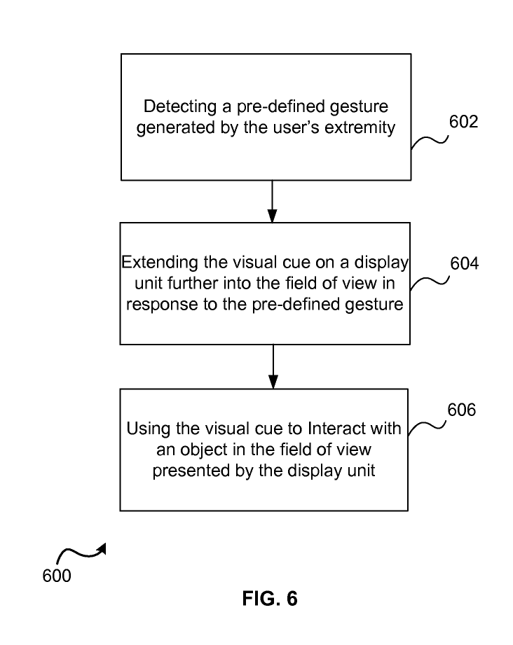

FIG. 6 is another simplified flow diagram, illustrating a method 600 for expanding the interaction radius in a computer vision application. The method 600 is performed by processing logic that comprise hardware (circuitry, dedicated logic, etc.), software (such as is run on a general purpose computing system or a dedicated machine), firmware (embedded software), or any combination thereof. In one embodiment, the method 600 is performed by device 900 of FIG. 9. The method 600 may be performed in the configurations described in FIG. 1, FIG. 2 and FIG. 3.

Referring to the example flow of FIG. 6, at block 602, the user generates a pre-defined gesture in the field of view of the input sensory device of the hand-held device. The hand-held device electronically detects the pre-defined gesture using the input sensory unit of the hand-held device. In one embodiment, the input sensory unit is a camera. The hand-held device may have a front-facing camera and/or a rear-facing camera. In some implementations, the front-facing camera and the display unit are placed on the same side of the hand-held device, so that the front facing camera is facing the user when the user is interacting with the display unit of the hand-held device. The rear-facing camera, in many instances, may be located on the opposite side of the hand-held device. While in use, the rear-facing camera coupled to the device may be facing in a direction away from the user. In response to the gesture, at block 604, the hand-held device extends the visual cue further into the field of view presented by the display unit. At block 606, the hand-held device employs the extended visual cue to interact with an object as manipulated by the user in the field of view presented by the display unit.

At block 604, the hand-held device detects extending of the reach of the user's extremity and allows the user to extend the reach of their extremity by extending the visual cue further out into the field of view presented in the display unit of the hand held device. The hand-held device may create the perception of extending the reach of the visual cue in a number of ways. In one implementation, the hand-held device may lengthen the representation of the extremity on the display unit. For example, if the visual cue is a finger, the hand-held device may further elongate the finger as presented to the user on the display unit. In another implementation, the hand-held device may narrow and sharpen the representation of the extremity on the hand-held device to give the user the perception that the extremity is reaching into the far distance in the field of view displayed by the display unit. The field of view displayed on the display unit may also be adjusted by zooming the image in and out to further increase the reach of the visual cue. The exemplary implementations described are non-limiting and the perception of reaching into the far distance by extending the reach of the visual cue may be generated by combining the techniques described herein, or by using other techniques that give the same visual effect of extending the reach of the visual cue as displayed on the display unit. At block 606, the extended visual cue allows the user to interact with objects far into the field of view displayed on the display unit. For example, the user can use the extended reach to reach out into a meadow of wild flowers and pluck the flower that the user is interested in.

It should be appreciated that the specific steps illustrated in FIG. 6 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 600.

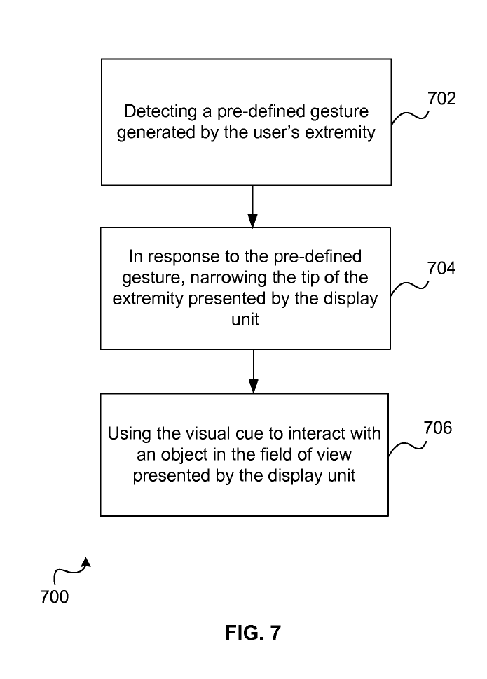

FIG. 7 is another simplified flow diagram, illustrating a method 700 for expanding the interaction radius in a computer vision application. The method 700 is performed by processing logic that comprises hardware (circuitry, dedicated logic, etc.), software (such as is run on a general purpose computing system or a dedicated machine), firmware (embedded software), or any combination thereof. In one embodiment, the method 700 is performed by device 900 of FIG. 9. The method 700 may be performed in the configuration settings described in FIG. 1, FIG. 2 and FIG. 3.

Referring to the example flow of FIG. 7, at block 702, the hand-held device detects a pre-defined gesture generated by the user in the field of view of the input sensory unit of the hand-held device. The pre-defined gesture is electronically detected by the input sensory unit of the device. In one embodiment, the input sensory unit is a camera. The hand-held device may have a front-facing camera and/or a rear-facing camera. In some implementations, the front-facing camera and the display unit are placed on the same side of the hand-held device, so that the front facing camera is facing the user when the user is interacting with the display unit of the hand-held device. The rear-facing camera, in many instances, may be located on the opposite side of the hand-held device. While in use, the rear-facing camera coupled to the device may be facing in a direction away from the user. In response to the pre-defined gesture, at block 704, the shape of a visual cue narrows and/or sharpens as presented by the display unit of the hand-held device. At block 706, the hand-held device employs the extended visual cue to interact with an object as manipulated by the user in the field of view presented by the display unit.

At block 704, the shape of a visual cue narrows and/or sharpens as presented by the display unit of the hand-held device. The narrower and sharper visual cue displayed on the display unit allows the user to use the visual cue as a pointing device or a wand. The visual cue may be the user's extremity. Examples of human extremities may include a finger, a hand, an arm or a leg. In one embodiment, as the user moves the extremity further into the distance, the visual cue becomes narrower and sharper. As the hand-held device detects the user moving the extremity back to its original position, the hand-held device may return the width and shape of the extremity to normal. Therefore, the width and the sharpness of the visual cue may be easily adjustable, as displayed by the display unit, by the user by moving the extremity back and forth. The visual cue generated by the hand-held device and displayed on the display unit using the user extremity also provides the benefits of finer granularity attributed to a wand. Narrowing and sharpening of the user's extremity as displayed on the display unit allows the user to select or manipulate objects at a much finer granularity. The use of the visual cue also allows the user to select and manipulate objects in a traditional display of objects by the display unit. For instance, the visual cue may allow the user to work with applications that need finer granularity and are feature rich like Photoshop® or simply select a person from a picture displaying a crowd. Similarly, in an augmented reality setting the instant access to a visual cue with fine granularity would allow the user to select a person with much greater ease from a crowd that is in the field of view of the rear-facing camera and displayed on the display unit of the hand-held device.

It should be appreciated that the specific steps illustrated in FIG. 7 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 7 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 700.

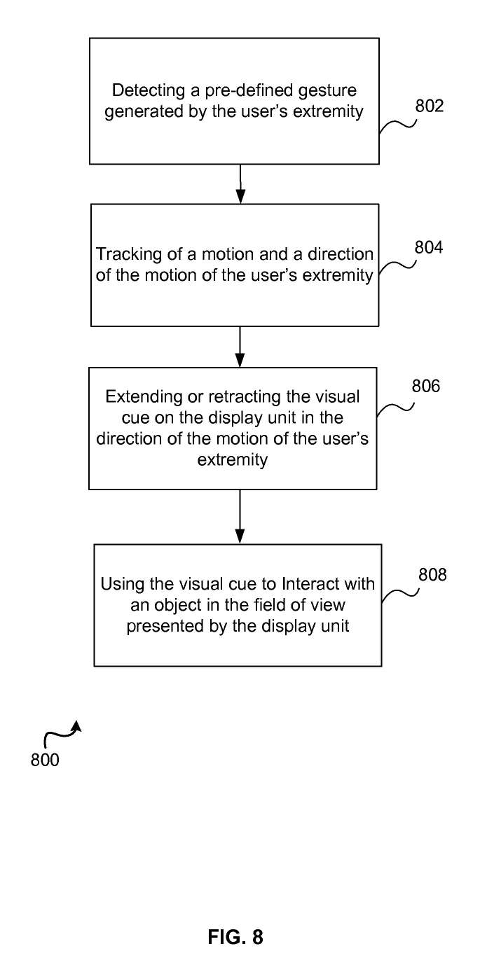

FIG. 8 is yet another simplified flow diagram, illustrating a method 800 for expanding the interaction radius in a computer vision application. The method 800 is performed by processing logic that comprise hardware (circuitry, dedicated logic, etc.), software (such as is run on a general purpose computing system or a dedicated machine), firmware (embedded software), or any combination thereof In one embodiment, the method 800 is performed by device 900 of FIG. 9. The method 800 may be performed in the configuration settings described in FIG. 1, FIG. 2 and FIG. 3.

Referring to FIG. 8, at block 802, the user generates a pre-defined gesture in the field of view of the input sensory device of the hand-held device. The pre-defined gesture is electronically detected by the input sensory unit of the device. In one embodiment, the input sensory unit is a camera. The hand-held device may have a front-facing camera and/or a rear-facing camera. In some implementations, the front-facing camera and the display unit are placed on the same side of the hand-held device, so that the front facing camera is facing the user when the user is interacting with the display unit of the hand-held device. The rear-facing camera, in many instances, may be located on the opposite side of the hand-held device. While in use, the rear-facing camera coupled to the device may be facing in a direction away from the user.

In response to the gesture, at block 804, the hand-held device starts tracking the motion and direction of motion of the user's extremity. In one embodiment, the hand-held device activates a special mode in response to detecting the pre-defined gesture at block 802. When the hand-held device is in this special mode, motion associated with certain extremities may be tracked for the duration that the hand-held device is in that special mode. The hand-held device may track the motion in a pre-defined direction or for a pre-defined speed or faster. At block 806, the visual cue extends further into the field of view presented by the display unit in response to the extremity moving further away from the camera. Similarly, if the user's extremity is retracted towards the camera, the visual cue may also retract in the field of view presented on the display unit. At block 808, the device employs the extended visual cue to interact with an object as manipulated by the user in the field of view presented by the display unit.

It should be appreciated that the specific steps illustrated in FIG. 8 provide a particular method of switching between modes of operation, according to an embodiment of the present invention. Other sequences of steps may also be performed accordingly in alternative embodiments. For example, alternative embodiments of the present invention may perform the steps outlined above in a different order. To illustrate, a user may choose to change from the third mode of operation to the first mode of operation, the fourth mode to the second mode, or any combination there between. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 800.

A computer system as illustrated in FIG. 9 may be incorporated as part of the previously described computerized device. For example, device 900 can represent some of the components of a hand-held device. A hand-held device may be any computing device with an input sensory unit like a camera and a display unit. Examples of a hand-held device include but are not limited to video game consoles, tablets, smart phones, point-and-shoot cameras, personal digital assistants and mobile devices. FIG. 9 provides a schematic illustration of one embodiment of a device 900 that can perform the methods provided by various other embodiments, as described herein, and/or can function as the host computer system, a remote kiosk/terminal, a point-of-sale device, a mobile device, a set-top box and/or a computer system. FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The device 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a camera, a mouse, a keyboard and/or the like; and one or more output devices 920, which can include without limitation a display unit, a printer and/or the like.

The device 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The device 900 might also include a communications subsystem 930, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 930 may permit data to be exchanged with a network (such as the network described below, to name one example), other computer systems, and/or any other devices described herein. In many embodiments, the device 900 will further comprise a non-transitory working memory 935, which can include a RAM or ROM device, as described above.

The device 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 925 described above. In some cases, the storage medium might be incorporated within a computer system, such as device 900. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the device 900 and/or might take the form of source and/or installable code, which, upon compilation and/or installation on the device 900 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system or device (such as the device 900) to perform methods in accordance with the disclosure. For example, some or all of the procedures of the described methods may be performed by the device 900 in response to processor 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein.

The terms “machine-readable medium” and “computer-readable medium,” as used herein, refer to any medium that participates in providing data that causes a machine to operate in a specific fashion. In an embodiment implemented using the device 900, various computer-readable media might be involved in providing instructions/code to processor(s) 910 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 925. Volatile media include, without limitation, dynamic memory, such as the working memory 935. Transmission media include, without limitation, coaxial cables, copper wire and fiber optics, including the wires that comprise the bus 905, as well as the various components of the communications subsystem 930 (and/or the media by which the communications subsystem 930 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the device 900. These signals, which might be in the form of electromagnetic signals, acoustic signals, optical signals and/or the like, are all examples of carrier waves on which instructions can be encoded, in accordance with various embodiments of the invention.

The communications subsystem 930 (and/or components thereof) generally will receive the signals, and the bus 905 then might carry the signals (and/or the data, instructions, etc. carried by the signals) to the working memory 935, from which the processor(s) 910 retrieves and executes the instructions. The instructions received by the working memory 935 may optionally be stored on a non-transitory storage device 925 either before or after execution by the processor(s) 910.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method to enhance computer vision applications, the method comprising:
electronically detecting at least one pre-defined gesture generated by a user's extremity as obtained by a camera coupled to a device;
in response to detecting the at least one pre-defined gesture, changing a shape of a visual cue on a display unit coupled to the device; and
updating the visual cue displayed on the display unit in response to detecting a movement of the user's extremity.

2. The method of claim 1, wherein changing the shape of the visual cue comprises extending the visual cue on the display unit further into a field of view presented by the display unit.

3. The method of claim 1, wherein the visual cue comprises a representation of the user's extremity, and wherein changing the shape of the visual cue comprises narrowing a tip of the representation of the user's extremity presented by the display unit.

4. The method of claim 1, wherein the device detects the pre-defined gesture generated by a user's extremity in a field of view of the camera, and wherein the camera is a rear-facing camera.

5. The method of claim 1, wherein the device detects the pre-defined gesture generated by a user's extremity in a field of view of the camera, and wherein the camera is a front-facing camera.

6. The method of claim 1, wherein the at least one pre-defined gesture comprises a first gesture and a second gesture, wherein upon detecting the first gesture the device activates a mode that allows changing the shape of the visual cue and upon detecting the second gesture the device changes the shape of the visual cue displayed on the display unit.

7. The method of claim 1, wherein the visual cue comprises a representation of an extension of the user's extremity displayed on the display unit coupled to the device.

8. The method of claim 1, wherein the visual cue comprises a virtual object selected by the at least one pre-defined gesture and displayed on the display unit coupled to the device.

9. The method of claim 2, wherein extending the visual cue on the display unit comprises:
tracking of the movement and a direction of the movement of the user's extremity; and
extending of the visual cue on the display unit in the direction of the movement of the user's extremity, wherein extending of the visual cue represented on the display unit of the device in a particular direction is directly proportional to the movement of the user's extremity in that direction.

10. The method of claim 1, wherein the device is one of a hand-held device, video game console, tablet, smart phone, point-and-shoot camera, personal digital assistant and mobile device.

11. A device, comprising:
a processor;
a camera coupled to the processor;
a display unit coupled to the processor; and
a non-transitory computer readable storage medium coupled to the processor, wherein the non-transitory computer readable storage medium comprises code executable by the processor for implementing a method comprising:
electronically detecting at least one pre-defined gesture generated by a user's extremity as obtained by the camera coupled to the device;
in response to detecting the at least one pre-defined gesture, changing a shape of a visual cue on a display unit coupled to the device; and
updating the visual cue displayed on the display unit in response to detecting a movement of the user's extremity.

12. The device of claim 11, wherein changing the shape of the visual cue comprises extending the visual cue on the display unit further into a field of view presented by the display unit.

13. The device of claim 11, wherein the visual cue comprises a representation of the user's extremity, and wherein changing the shape of the visual cue comprises narrowing a tip of the representation of the user's extremity presented by the display unit.

14. The device of claim 11, wherein the at least one pre-defined gesture comprises a first gesture and a second gesture, wherein upon detecting the first gesture the device activates a mode that allows changing the shape of the visual cue and upon detecting the second gesture the device changes the shape of the visual cue displayed on the display unit.

15. The device of claim 11, wherein the visual cue comprises a representation of an extension of the user's extremity displayed on the display unit coupled to the device.

16. The device of claim 11, wherein the visual cue comprises a virtual object selected by the at least one pre-defined gesture and displayed on the display unit coupled to the device.

17. The device of claim 12, wherein extending the visual cue on the display unit comprises:
tracking of the movement and a direction of the movement of the user's extremity; and
extending of the visual cue on the display unit in the direction of the movement of the user's extremity, wherein extending of the visual cue represented on the display unit of the device in a particular direction is directly proportional to the movement of the user's extremity in that direction.

18. A non-transitory computer readable storage medium coupled to a processor, wherein the non-transitory computer readable storage medium comprises a computer program executable by the processor for implementing a method comprising:
electronically detecting at least one pre-defined gesture generated by a user's extremity as obtained by a camera coupled to a device;
in response to detecting the at least one pre-defined gesture, changing a shape of a visual cue on a display unit coupled to the device; and
updating the visual cue displayed on the display unit in response to detecting a movement of the user's extremity.

19. The non-transitory computer readable storage of claim 18, wherein changing the shape of the visual cue comprises extending the visual cue on the display unit further into a field of view presented by the display unit.

20. The non-transitory computer readable storage of claim 18, wherein the visual cue comprises a representation of the user's extremity, and wherein changing the shape of the visual cue comprises narrowing a tip of the representation of the user's extremity presented by the display unit.

21. The non-transitory computer readable storage of claim 18, wherein the at least one pre-defined gesture comprises a first gesture and a second gesture, wherein upon detecting the first gesture the device activates a mode that allows changing the shape of the visual cue and upon detecting the second gesture the device changes the shape of the visual cue displayed on the display unit.

22. The non-transitory computer readable storage of claim 18, wherein the visual cue comprises a representation of an extension of the user's extremity displayed on the display unit coupled to the device.

23. The non-transitory computer readable storage of claim 18, wherein the visual cue comprises a virtual object selected by the at least one pre-defined gesture and displayed on the display unit coupled to the device.

24. The non-transitory computer readable storage of claim 19, wherein extending the visual cue on the display unit comprises:
tracking of the movement and a direction of the movement of the user's extremity; and
extending of the visual cue on the display unit in the direction of the movement of the user's extremity, wherein extending of the visual cue represented on the display unit of the device in a particular direction is directly proportional to the movement of the user's extremity in that direction.

25. An apparatus performing a method to enhance computer vision, the method comprising:
means electronically detecting at least one pre-defined gesture generated by a user's extremity as obtained by a camera coupled to a device;
in response to detecting the at least one pre-defined gesture, means for changing a shape of a visual cue on a display unit coupled to the device; and
means for updating the visual cue displayed on the display unit in response to detecting a movement of the user's extremity.

26. The apparatus of claim 25, wherein changing the shape of the visual cue comprises means for extending the visual cue on the display unit further into a field of view presented by the display unit.

27. The apparatus of claim 25, wherein the visual cue comprises a representation of the user's extremity, and wherein changing the shape of the visual cue comprises narrowing a tip of the representation of the user's extremity presented by the display unit.

28. The apparatus of claim 25, wherein the at least one pre-defined gesture comprises a first gesture and a second gesture, wherein upon detecting the first gesture the device provides a means for activating a mode that allows changing the shape of the visual cue and upon detecting the second gesture the device provides a means for changing the shape of the visual cue displayed on the display unit.

29. The apparatus of claim 25, wherein the visual cue comprises a representation of an extension of the user's extremity displayed on the display unit coupled to the device.

30. The apparatus of claim 25, wherein the visual cue comprises a virtual object selected by the at least one pre-defined gesture and displayed on the display unit coupled to the device.

31. The apparatus of claim 26, wherein extending the visual cue on the display unit comprises:
means for tracking of the movement and a direction of the movement of the user's extremity; and
means for extending of the visual cue on the display unit in the direction of the movement of the user's extremity, wherein extending of the visual cue represented on the display unit of the device in a particular direction is directly proportional to the movement of the user's extremity in that direction.
